(19) United States
(12) Patent Application Publication
(10) Pub. No.: US 2022/0053050 A1
(43) Pub. Date: Feb. 17, 2022

(54) INFORMATION PROCESSING SYSTEM, PROCESS EXECUTING SYSTEM, PROCESS EXECUTING METHOD, AND RECORDING MEDIUM

(71) Applicant: Keiichi INOUE, Kanagawa (JP)

(72) Inventor: Keiichi INOUE, Kanagawa (JP)

(73) Assignee: Ricoh Company, Ltd., Tokyo (JP)

(21) Appl. No.: 17/444,486

(22) Filed: Aug. 5, 2021

(30) Foreign Application Priority Data
Aug. 11, 2020 (JP) 2020-135661

(51) Int. Cl. H04L 29/08; H04L 12/14; H04L 12/26

(52) U.S. Cl. CPC H04L 67/1008; H04L 43/0817; H04L 12/1439

(57) ABSTRACT

An information processing system configured to communicate with an apparatus and an external server and to perform a series of processes specified by the apparatus is provided. The information processing system includes a memory, and a processor coupled to the memory and configured to identify a program that is executed in the external server based on the series of processes specified by the apparatus, and control the operational state of the external server in which the identified program is executed.

### CROSS-REFERENCE TO RELATED APPLICATION

The present application claims priority under 35 U.S.C. § 119 to Japanese Patent Application No. 2020-135661, filed on Aug. 11, 2020, the entire contents of which are incorporated herein by reference.

### BACKGROUND OF THE INVENTION

### 1. Field of the Invention

The disclosures herein generally relate to an information processing system, a process executing system, a process executing method, and a recording medium.

### 2. Description of the Related Art

An information processing system in which a user selects and executes a process flow is known. Specifically, in the information processing system, the user selects processes from a plurality of processes, registers the processes in a given order as a process flow, selects a process flow from a plurality of registered process flows, and executes the selected process flow. The information processing system provides the user with a graphical web application such that the user can create a process flow on a web browser or the like. However, because a cloud server or the like is used to perform a process flow, the cost of using the cloud server may be required.

A technology that reduces costs required for a system performing a plurality of processes is devised (see Patent Document 1, for example). Patent Document 1 describes a computer system that includes a plurality of host computers. In Patent Document 1, power consumption of the entire computer system is reduced by shifting the host computers to a suspended state, while reducing the time waiting for the host computers in the suspended state to become ready for use. As a result, the performance of the entire computer system can be improved.

However, in the related-art technology, the operational state of an external server cannot be controlled in accordance with a program included in a process flow. The user uses a web application to create a process flow by combining components. The components are programs that perform processes included in the process flow. These programs may be developed by an external vendor (subcontractor).

In order to prevent such programs developed by an external vendor from affecting other programs or decreasing the quality of the entire service, the programs may be stored and executed in an external server. However, because the external server is implemented on a pay-per-use basis, costs increase in proportion to the period of time during which the external server is in operation. For this reason, it is desirable for the service provider to start the external server when the external server needs to be used, and stop the external server when the external server does not need to be used. However, as it is difficult for the service provider to identify in advance what program in the external server is used by whom, the external server is required to be in operation at all times, thus requiring unnecessary costs.

### RELATED-ART DOCUMENTS

### Patent Documents

### Patent Document 1: Japanese Unexamined Patent Application Publication No. 2008-225639

### SUMMARY OF THE INVENTION

In one embodiment, an information processing system configured to communicate with an apparatus and an external server and to perform a series of processes specified by the apparatus is provided. The information processing system includes a memory, and a processor coupled to the memory and configured to identify a program that is executed in the external server based on the series of processes specified by the apparatus, and control the operational state of the external server in which the identified program is executed.

### BRIEF DESCRIPTION OF THE DRAWINGS

FIG. 1 is a diagram illustrating an example of a system configuration of a process executing system according to an embodiment;

FIG. 2 is a diagram illustrating an example of a hardware configuration of a computer system;

FIG. 3 is a diagram illustrating an example of a hardware configuration of an image forming apparatus;

FIG. 4 is a functional block diagram illustrating functions of the process executing system;

FIG. 5 is a diagram schematically illustrating an example of component information;

FIGS. 6A through 6C are diagrams schematically illustrating application information;

FIG. 7 is a functional block diagram illustrating functions of an I/O logic processing unit;

FIG. 8 is a functional block diagram illustrating functions of a component processing unit of an external component service;

FIG. 9 is a diagram illustrating examples of common I/Fs and unique I/Fs;

FIG. 10 is a sequence diagram illustrating an example of a process flow performed by an information processing system;

FIG. 11 is a sequence diagram illustrating an example of a process flow executed by a component processing unit;

FIG. 12 is a sequence diagram in which the I/O logic processing unit performs a process flow that includes components located in the external component service and components located in the information processing system;

FIG. 13A is a sequence diagram (part 1) illustrating an example in which the information processing system performs a process flow and controls the operational state of an external server;

FIG. 13B is a sequence diagram (part 2) illustrating the example in which the information processing system performs the process flow and controls the operational state of the external server;

FIG. 14 is a diagram illustrating an example of a process flow that includes a plurality of components;

FIG. 15A and FIG. 15B are diagrams illustrating process flows that include a plurality of components, which are performed in parallel by a plurality of users;

FIG. 16 is a diagram illustrating an example of an external component service management database, which is included in the information processing system if the information processing system has a redundant configuration;

FIG. 17 is a diagram illustrating the structure of an external component service management database;

FIG. 18A is a sequence diagram (part 1) illustrating an example of a process flow performed by the information processing system having a redundant configuration; and

FIG. 18B is a sequence diagram (part 2) illustrating the example of the process flow performed by the information processing system having the redundant configuration.

### DESCRIPTION OF THE EMBODIMENTS

It is a general object of the present invention to control the operational state of an external server in accordance with a program included in a process flow.

In the following, a process executing system and a process executing method performed by the process executing system according to embodiments of the present invention will be described with reference to the accompanying drawings.

### <Outline of Method for Performing Process Flow According to Embodiment>

A process flow includes components in order of execution. When a user selects a process flow and the process executing system performs the process flow, the components are executed in order of execution. Some of the components included in the process flow may be stored in and managed by external servers. It is predetermined which external servers manage and store which components.

In the following embodiments, the information processing system determines, on a per-component basis, whether to continue the operation of an external server in which a component is executed. If the information processing system determines that the operation of the external server is not required, the information processing system stops the operation of the external server. Accordingly, unnecessary costs related to management and storage of components by external servers can be reduced.

### <Terminology>

The term “component” refers to a program that performs a process included in a series of processes. The component may also be referred to as a module, a plug-in, or an add-in.

The term “external server” refers to a server located outside the information processing system. The use of the “external server” incurs costs.

The term “series of processes” refers to one or more processes performed in a predetermined order. Such one or more processes may be referred to as a workflow.

The term “operational state” refers to whether a device is in operation. In the case of a server, the “operational state” refers to a state indicating whether the server is available to a user. In the following embodiments, the “operational state” refers to a state indicating whether or not a charge is issued.

### <System Configuration>

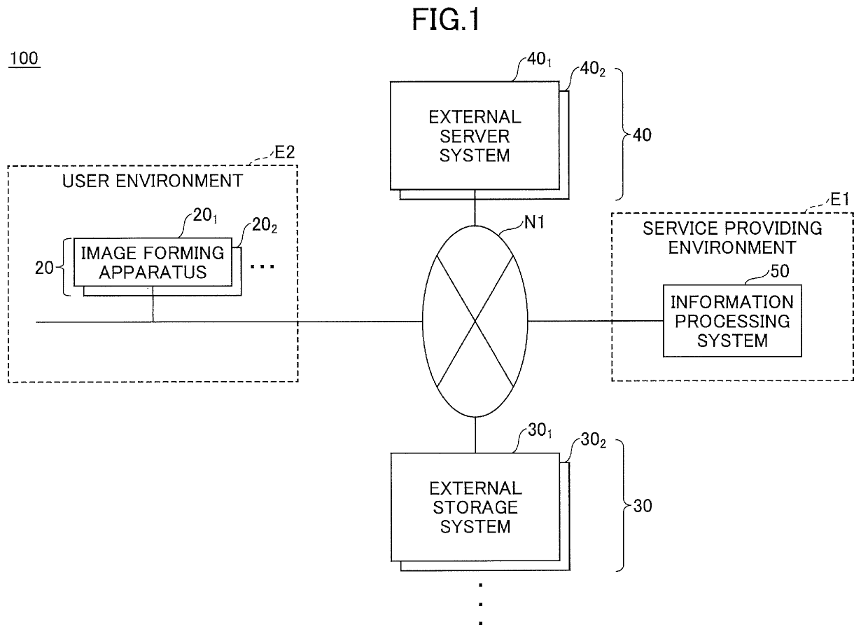

FIG. 1 is a diagram illustrating an example of a system configuration of a process executing system 100 according to an embodiment. In the process executing system 100, an external server system 40, an apparatus (image forming apparatus) 20 in a user environment E2, an external storage system 30, and an information processing system 50 in a service providing environment E1 can communicate with each other via a network N1.

The service providing environment E1 is a system environment that provides services such as a cloud service via the network N1. In the present embodiment, a cloud service is described as a specific example of an external service; however, any services, such as a service provided by an application service provider (ASP) and a web service, may be provided via the network N1.

The service providing environment E1 includes the information processing system 50 that is implemented by one or more information processing apparatuses. The information processing system 50 provides various services via the network N1. For example, the information processing system 50 provides a service (a scan delivery service), in which an electronic file, generated by scanning an original document with the apparatus 20 of the user environment E2, is subjected to an optical character reader (OCR) and stored in the external storage system 30. Further, for example, the information processing system 50 provides a service (a cloud print service) in which an electronic file stored in the external storage system 30 is printed by the apparatus 20 of the user environment E2. In the present embodiment, the information processing system 50 provides services such as the scan delivery service and the cloud print service.

However, the services provided by the information processing system 50 are not limited thereto, and may include a service in which an electronic file stored in the external storage system 30 is projected by a projector included in the user environment E2. Further, the services provided by the information processing system 50 may include a service in which an electronic file, generated by scanning an original document with the apparatus 20, is subjected to OCR, then translated into a predetermined language (for example, English to Japanese), and stored in the external storage system 30.

The entirety of or a part of the information processing system 50 may be included in the user environment E2. In other words, all or some of the information processing apparatuses constituting the information processing system 50 may be included in the user environment E2 (on-premises).

The user environment E2 is, for example, a system environment in a company to which a user using the apparatus 20 belongs. In the user environment E2, one or more apparatuses 20 are connected to each other via a network such as a local area network (LAN).

The apparatus 20 according to the present embodiment is an example of an image forming apparatus having a print function and a scan function. The image forming apparatus may be a multifunction peripheral/printer/product (MPF) or the like having a copy function, a facsimile (FAX) communication function, and the like, in addition to the print function and the scan function.

The external storage system 30 includes one or more information processing apparatuses, and provides a cloud service called a storage service (or an online storage) via the network. The storage service is a service for leasing a storage space of the external storage system 30. Examples of the storage service include commercial services such as BOX (registered trademark) and OneDrive (registered trademark).

In the present embodiment, in the scan delivery service, an electronic file subjected to OCR is stored (uploaded) in a storage space leased from the external storage system 30. Further, in the present embodiment, in the cloud print service, an electronic file to be printed is obtained (downloaded) from a storage space leased from the external storage system 30. Note that, in order to distinguish a plurality of external storage systems 30, an “external storage system 30₁”, an “external storage system 30₂”, and so on are used. Further, the name of a service provided by the external storage system 30₁ is referred to as a “storage service A”, and the name of a service provided by the external storage system 30₂ is referred to as a “storage service B”.

The external storage system 30 may be a system implemented by a plurality of information processing apparatuses. Further, the configuration of the information processing system 50 illustrated in FIG. 1 is merely an example, and the information processing system 50 may have any other configuration. For example, as described above, the user environment E2 may include various apparatuses such as a projector and an interactive whiteboard in addition to or in place of the image forming apparatus.

The external server system 40 includes one or more information processing apparatuses, and manages and executes components developed mainly by an external vendor. However, components developed by the operator of the information processing system 50 may be managed and executed, and components developed by any developer can be managed and executed. The external server system 40 is an on-demand cloud service that allows users to use functions of the information processing apparatuses. The external server system 40 issues a charge for the time, the capacity, the function (the number of CPUs), or the like. The contracted customer can use a resource provided by the external server system 40 as the customer's own external server. In the present embodiment, a dedicated external server system can be allocated to each vendor. However, an external server system is not necessarily allocated to each vendor, and a plurality of components developed by a plurality of vendors may be executed in a single external server system.

Examples of the cloud service include infrastructure as a service (IaaS) and platform as a service (PaaS). Further, Google Compute Engine, Amazon Elastic Compute Cloud (registered trademark), and the like are known as commercial services. In order to distinguish a plurality of external server systems 40, an “external server system 40₁”, an “external server system 40₂”, and so on are used.

### <Hardware Configuration>

### <<Computer System>>

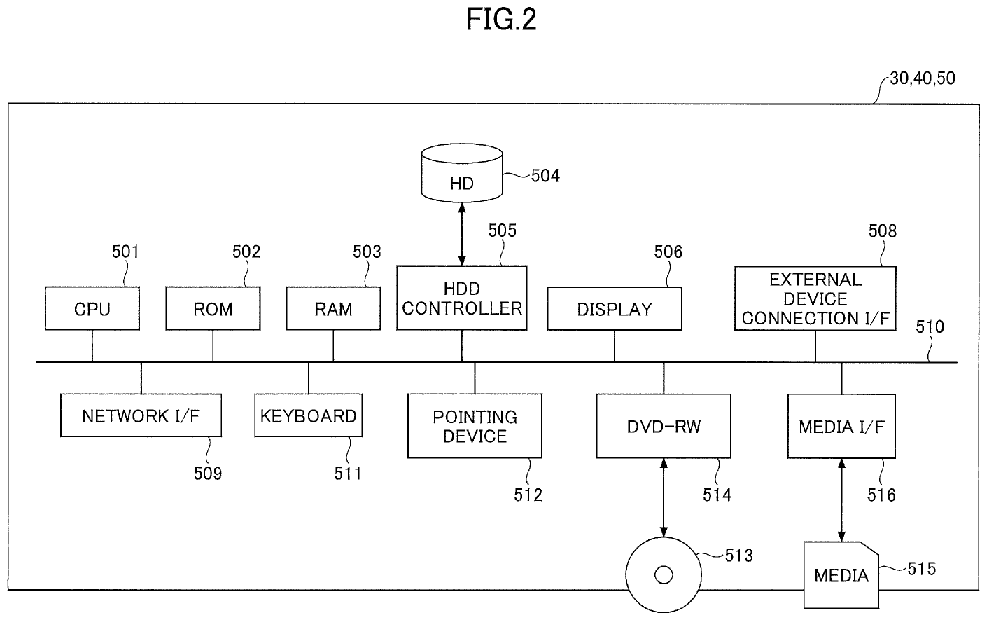

FIG. 2 is a diagram illustrating a hardware configuration of a computer system. Each of the external server system 40, the external storage system 30, and the information processing system 50 includes the hardware configuration illustrated in FIG. 2.

As illustrated in FIG. 2, the computer system includes a central processing unit (CPU) 501, a read-only memory (ROM) 502, a random-access memory (RAM) 503, a hard disk (HD) 504, a hard disk drive (HDD) controller 505, a display 506, an external device connection interface (I/F) 508, a network I/F 509, a bus line 510, a keyboard 511, a pointing device 512, a digital versatile disk rewritable (DVD-RW) drive 514, and a media I/F 516.

The CPU 501 controls the operation of the entire computer system. The ROM 502 stores a program such as an initial program loader (IPL) used to drive the CPU 501. The RAM 503 is used as a work area for the CPU 501. The HD 504 stores various types of data such as programs. The HDD controller 505 controls reading and writing of various types of data from and to the HD 504, as controlled by the CPU 501. The display 506 displays various information such as a cursor, menus, windows, characters, and images. The external device connection I/F 508 is an interface for connecting various external devices. Examples of the external devices include a universal serial bus (USB) memory and a printer. The network I/F 509 is an interface for data communication via a communication network. The bus line 510 is an address bus, a data bus, or the like for electrically connecting the components, such as the CPU 501, illustrated in FIG. 2.

The keyboard 511 is an example of an input device including multiple keys for inputting characters, numerical values, and various instructions. The pointing device 512 is an example of an input device configured to select and execute various instructions, select an object, and move a cursor. The DVD-RW drive 514 controls reading and writing of various types of data from and to a DVD-RW 513, which is an example of a removable recording medium. The DVD-RW 513 may be a different type of recording medium such as a DVD-R. The media I/F 516 controls reading and writing (storing) of data from and to a recording medium 515 such as a flash memory.

### <<Image Forming Apparatus>>

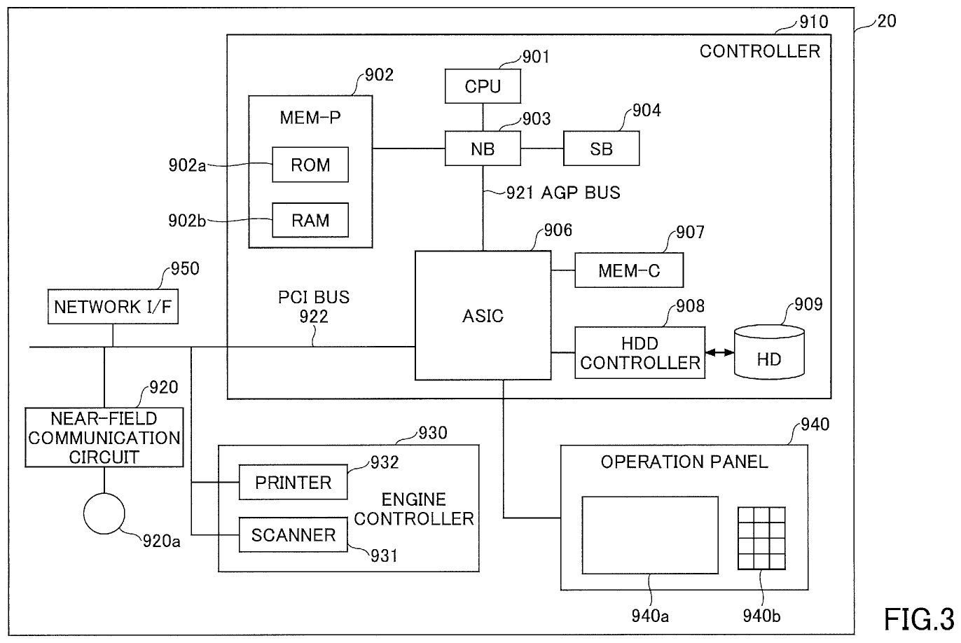

FIG. 3 is a diagram illustrating a hardware configuration of the image forming apparatus. As illustrated in FIG. 3, the image forming apparatus includes a controller 910, a near-field communication circuit 920, an engine controller 930, an operation panel 940, and a network I/F 950.

The controller 910 includes a CPU 901 that is a main component of a computer, a system memory (MEM-P) 902, a north bridge (NB) 903, a south bridge (SB) 904, an application-specific integrated circuit (ASIC) 906, a local memory (MEM-C) 907 that is a storage device, an HDD controller 908, and an HD 909 that is a storage device. The NB 903 and the ASIC 906 are connected to each other via an accelerated graphics port (AGP) bus 921.

The CPU 901 is a controller that controls the entire image forming apparatus. The NB 903 is a bridge for connecting the CPU 901, the MEM-P 902, the SB 904, and the AGP bus 921 to each other, and includes a memory controller for controlling reading and writing of data from and to the MEM-P 902, a peripheral component interconnect (PCI) master, and an AGP target.

The MEM-P 902 includes a ROM 902a and a RAM 902b. The ROM 902a is a memory that stores programs and data for implementing functions of the controller 910. The RAM 902b is a memory used to load programs and data and for image rendering performed by a printer. A program stored in the RAM 902b may be recorded and provided in a computer-readable recording medium such as a CD-ROM, a CD-R or a DVD in an installable format or an executable format file.

The SB 904 is a bridge that connects the NB 903 to PCI devices and peripheral devices. The ASIC 906 is an integrated circuit (IC) for use in image processing and having hardware elements for image processing. The ASIC 906 serves as a bridge that connects the AGP bus 921, a PCI bus 922, the HDD controller 908, and the MEM-C 907. The ASIC 906 includes a PCI target and an AGP master, an arbiter (ARB) that forms the core of the ASIC 906, a memory controller that controls the MEM-C 907, a plurality of direct memory access controllers (DMACs) that rotate image data using hardware logics, and a PCI unit that transfers data between a scanner 931 and a printer 932 via the PCI bus 922. Note that a USB interface and an Institute of Electrical and Electronics Engineers (IEEE) 1394 interface may be connected to the ASIC 906.

The MEM-C 907 is a local memory used as a copy image buffer and a code buffer. The HD 909 is a storage device that stores image data, font data used at the time of printing, and forms. The HDD controller 908 controls reading and writing of data from and to the HD 909, as controlled by the CPU 901. The AGP bus 921 is a bus interface for a graphics accelerator card introduced to accelerate graphics processes. The AGP bus 921 directly accesses the MEM-P 902 with a high throughput, thereby accelerating processes related to the graphics accelerator card.

The near-field communication circuit 920 includes a near-field communication antenna 920a. The near-field communication circuit 920 is a communication circuit complying to near-field communication (NFC) or Bluetooth (registered trademark).

The engine controller 930 includes the scanner 931 and the printer 932. The operation panel 940 includes a panel display 940a such as a touch panel, and also includes a hardware keyboard 940b. The panel display 940a displays current setting values and a selection screen, and receives an input from an operator. The hardware keyboard 940b includes a numeric keypad that receives setting values related to image forming conditions such as density setting conditions and also includes a start key that receives an instruction to start copying. The controller 910 performs overall control of the image forming apparatus, and controls image rendering, communication, and inputs from the operation panel 940. The scanner 931 or the printer 932 includes an image processing section such as error diffusion or gamma correction.

In addition, the image forming apparatus may use an application switching key of the operation panel 940 to switch between a document box function, a copy function, a printer function, and a facsimile function. When the document box function is selected, a document box mode is set, when the copy function is selected, a copy mode is set, when the printer function is selected, a printer mode is set, and when the facsimile function is selected, a facsimile mode is set.

The network I/F 950 is an interface for data communication via a communication network. The near-field communication circuit 920 and the network I/F 950 are electrically coupled to the ASIC 906 via the PCI bus 922.

### <Functions of Process Executing System>

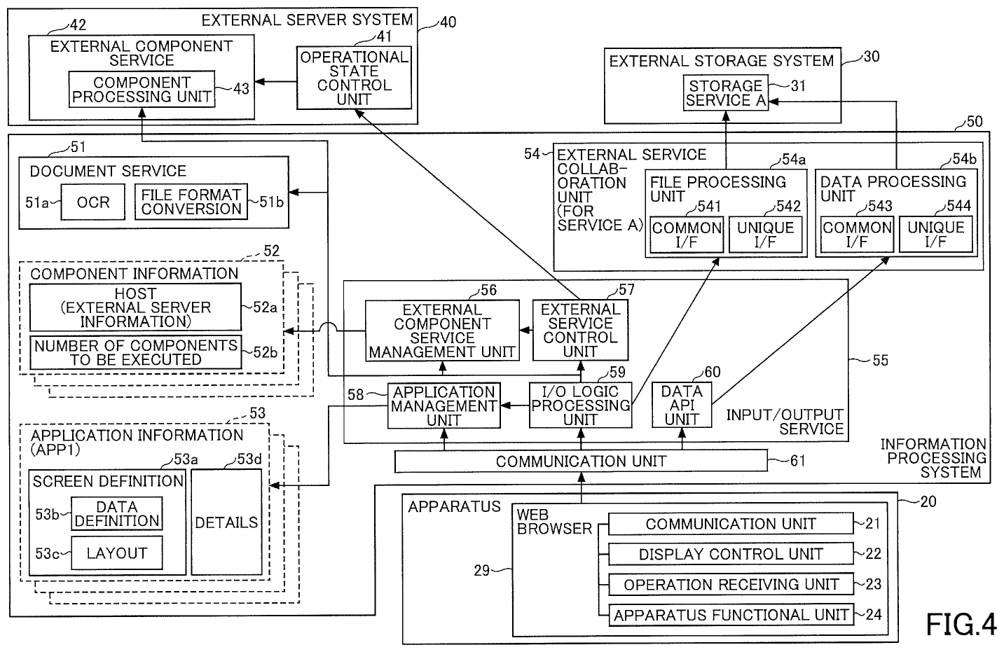

FIG. 4 is a functional block diagram illustrating functions of the process executing system.

### <<Information Processing System>>

First, the information processing system 50 includes a document service 51, an external service collaboration unit 54, an input/output service 55, and a communication unit 61. The functions included in the information processing system 50 are implemented by executing any of the elements illustrated in FIG. 2, in response to a command from the CPU 501 in accordance with a program loaded from the HD 504 into the RAM 503.

Further, the information processing system 50 stores component information 52 and application information 53. The component information 52 is information on components to be executed. The component information 52 and the application information 53 are stored in a storage of the HD 504, the RAM 503, or the like illustrated in FIG. 2.

The communication unit 61 transmits and receives various information to and from the apparatus 20. In the present embodiment, the communication unit 61 transmits screen information and the like to the apparatus 20 for display, and receives image data, files, and the like, read by the apparatus 20, from the apparatus 20. Although not illustrated for simplicity, the communication unit 61 also communicates with the external server system 40 and the external storage system 30.

The input/output service 55 includes an external component service management unit 56, an external service control unit 57, an application management unit 58, an I/O logic processing unit 59, and a data API unit 60.

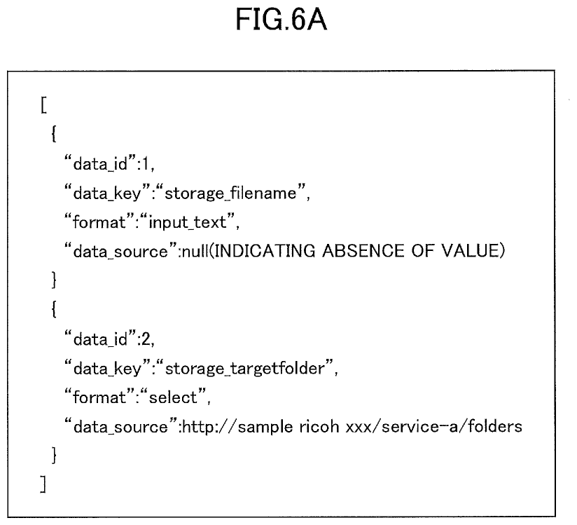

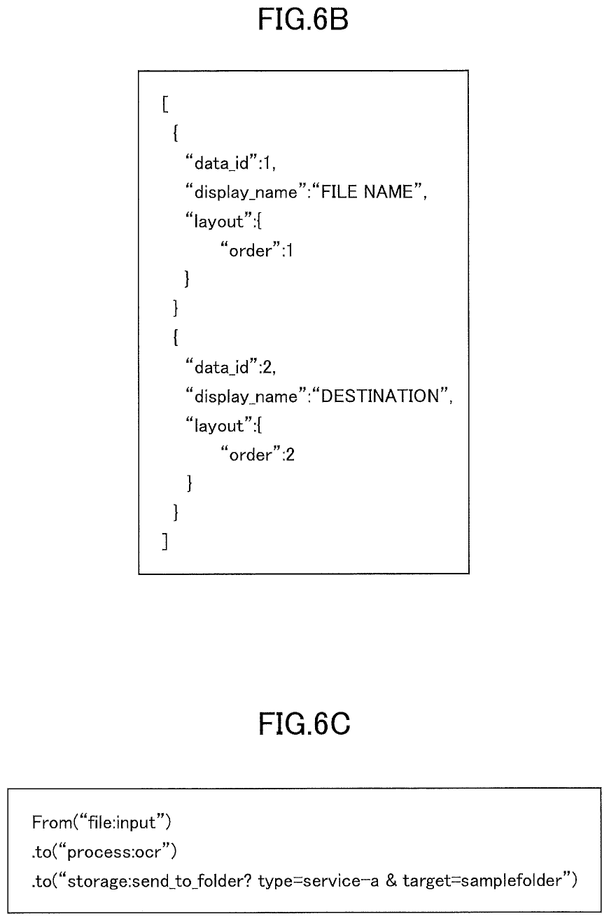

The application management unit 58 manages the application information 53, and uses the application information 53 to generate screen information related to an application. The screen information is displayed on a web browser. The application refers to a single process flow. The screen information may be created by HTML, XML, cascade style sheet (CSS), or JavaScript (registered trademark). Identification information such as “app1” is assigned to the application information 53. The application information 53 related to the one application includes a data definition, a layout, and details. Details of the application information will be described with reference to FIG. 6.

The I/O logic processing unit 59 analyzes “details” included in the application information 53, and requests the document service 51, the external service collaboration unit 54, or an external component service 42 to perform a process. Further, the I/O logic processing unit 59 controls the operational state of an external server. Thus, the I/O logic processing unit 59 controls the external component service management unit 56 and the external service control unit 57.

The data API unit 60 obtains information such as a list of folders and a list of files of the external storage system via the external service collaboration unit 54 (a file processing unit 54a or a data processing unit 54b).

The external service control unit 57 determines whether to start or stop an external server based on the component information 52, and controls the operational state of the external server. The external component service 42 runs on the started external server.

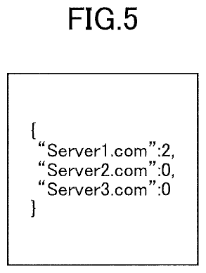

The external component service management unit 56 manages the component information 52. That is, the external component service management unit 56 registers the number of components to be executed on each external server, and decreases the number by one each time the execution of a component is completed. An example of the component information 52 is depicted in FIG. 5.

The external service collaboration unit 54 includes the file processing unit 54a and the data processing unit 54b. The file processing unit 54a performs a process related to input/output of a file into/from the external storage system 30. The data processing unit 54b performs a process for obtaining/writing data from/to the external storage system 30. Note that the file processing unit 54a and the data processing unit 54b are provided for each external storage system 30. Therefore, in order to increase the number of external storage systems 30, the number of external service collaboration units 54 needs to be increased.

The document service 51 is a service group that processes documents. In the example of FIG. 4, the document service 51 includes an OCR service 51a and a file format conversion service 51b. In addition, the document service 51 may include services such as an image size changing service and a translation service. These services are also components.

FIG. 5 is a diagram schematically illustrating an example of the component information 52. The component information 52 is information in which a host (external server information) is associated with the number of components to be executed. The host is denoted as “Server1.com” or the like. The host is information (such as a URL or a domain name) for identifying or specifying an external server in which components to be executed are located. The number of components to be executed is the number of components to be executed in each external server. The number of components to be executed decreases by one each time a component is executed. Accordingly, the external service control unit 57 can determine whether to start or stop an external server by referring to the remaining number of components.

FIGS. 6A through 6C are diagrams schematically illustrating the application information 53. The application information 53 includes a screen definition (a data definition and a layout) and details.

FIG. 6A depicts an example of a data definition. The data definition is the definition of data to be transmitted/received (such as the name of each item on a user interface (UI) and the name of data stored in each item).
data_id: Identification information of data.
data_key: A data name (parameter for a process), such as the name of a file in which the data is stored.
format: File format, such as “input_text”, “textarea”, “select”, or “radio” similar to HTML form elements.
data_source: A URL that retains the data, or a direct link to the data.

FIG. 6B depicts an example of a layout. The layout is a screen design (information used by a web browser to display a screen for the user).
data_id: Identification information of the data (corresponding to “data_id” in the data definition).
display_name: A file name.
layout: Position information of an item. In the example of FIG. 6B, the order of items indicates that the items are displayed from the top. The position information may be coordinates information. Further, if the client (apparatus) uses a client application instead of a web browser, or if the client (apparatus) displays complicated screen data, the “layout” information is not necessarily included, and the items may be displayed by interpreting the data definition in the process of generating a screen.

FIG. 6C depicts an example of details of a process flow. The apparatus 20 is provided with a list of process flows, and in response to receiving the user's selection of a process flow, the selected process flow is specified for the information processing system 50. In a process flow, a process performed in an external server, a process performed with the document service 51 or the external storage system 30, and the like are described.

Each process includes elements such as a “component name”, a “process”, and an “option parameter”.

For example, a process may be described as “<component name>:<process>?<option parameter>”. This indicates that “a file with a file name “test.pdf” is transmitted to a folder “samplefolder” of a storage service A”.

Specifically, the above process is described as “storage: send_to_folder?type=service-a & targetfolder=samplefolder & filename=test.pdf”. In the example of FIG. 6C, the details of the process flow include an “OCR” process and “service A (=delivery)”. In addition, “From (“file:input”)” indicates that the process flow is started in response to a file being input.

### <<External Server System>>

Referring back to FIG. 4, the external server system 40 includes the external component service 42 and an operational state control unit 41. The functions included in the external server system 40 are implemented by executing any of the elements illustrated in FIG. 2, in response to a command from the CPU 501 in accordance with a program loaded from the HD 504 into the RAM 503.

The external component service 42 executes components developed mainly by an external vendor. The external component service 42 includes a component processing unit 43. The component processing unit 43 includes various components, and performs processes similar to those performed by the document service 51 and the external service collaboration unit 54.

The operational state control unit 41 starts or stops an external server. When the external server is started, the operational state control unit 41 starts the external component service 42. The external component service 42 may be automatically started in conjunction with the start of the external server.

The operational state control unit 41 is an application interface (API) provided by the external server system 40. When the external service control unit 57 calls the operational state control unit 41 with a request to start an external server, the operational state control unit 41 starts an external server that includes designated server elements (such as the CPU, the RAM, the HDD, and the SSD). Then, the operational state control unit 41 starts the external component service 42.

In the external server system 40, an external server is provided in response to the start of the operational state control unit 41. That is, a resource is secured in response to a request from the external service control unit 57 or in response to a contract for a cloud service. The operational state control unit 41 installs an operating system (OS) in the resource, starts the external component service 42, and executes components included in a process flow. Therefore, securing or releasing the external server includes starting or stopping the external component service 42. A process performed by the operational state control unit 41 may vary depending on the service form of the external server system 40. In the present embodiment, starting the external component service 42 means that a charge is issued, and stopping the external component service 42 means that a charge is not issued.

When the external service control unit 57 calls the operational state control unit 41 with a request to stop the external server, the operational state control unit 41 stops the external server. The operational state control unit 41 stops the external component service service 42 before stopping the external server, or stops the external component service 42 simultaneously when stopping the external server. The external component service 42 is stopped in accordance with the specifications of the external server system 40.

### <<External Storage System>>

The external storage system 30 includes one or more storage services 31. The storage service A, which is one of the storage services 31, may be a cloud storage service or any other service provided by a contracted provider.

### <<Apparatus>>

A web browser 29 runs on the apparatus 20. The web browser 29 includes a communication unit 21, a display control unit 22, an operation receiving unit 23, and an apparatus functional unit 24. The functional units included in the apparatus 20 are implemented by causing the CPU 901 to execute commands included in one or more programs installed in the apparatus 20. For example, the communication unit 21, the display control unit 22, and the operation receiving unit 23 are implemented by the web browser, and the apparatus functional unit 24 is implemented by each application (native application).

The communication unit 21 transmits and receives various information to and from the information processing system 50. In the present embodiment, the communication unit 21 receives screen information and the like from the information processing system 50, and transmits image data, files, and the like, read by the apparatus 20, to the information processing system 50.

The display control unit 22 interprets screen information of various screens, and displays the screen information on the panel display 940a. The operation receiving unit 23 receives operations performed by the user on the various screens displayed on the panel display 940a. The apparatus functional unit 24 includes various functions of the apparatus 20, such as a scanner function to create image data by reading a document and a function to transmit a facsimile or an email.

### <Functions of I/O Logic Processing Unit>

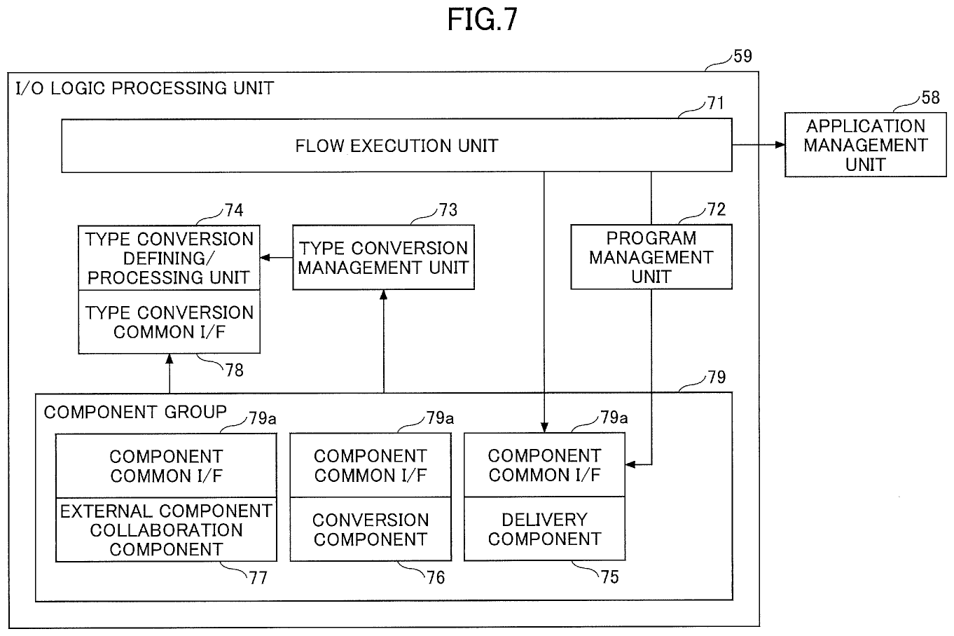

FIG. 7 is a functional block diagram illustrating functions of the I/O logic processing unit 59. The I/O logic processing unit 59 includes a flow execution unit 71, a program management unit 72, a type conversion management unit 73, a type conversion defining/processing unit 74, and a component group 79.

The flow execution unit 71 interprets and executes processes included in “details” of a process flow, obtained from the application management unit 58. The flow execution unit 71 calls a component in accordance with the details of the process flow, and executes the component.

The program management unit 72 retains the types of components included in the component group 79. The program management unit 72 generates a component in response to a request from the flow execution unit 71. Further, the program management unit 72 determines whether a component is located in an external server or in the information processing system 50 by referring to a determination table indicated in Table 1.

The component group 79 is a group of one or more components managed by the program management unit 72. The components have respective component common I/Fs 79a. The component common I/Fs 79a are APIs through which the flow execution unit 71 calls the components. The component common I/Fs 79a are the same even if the components are different. Therefore, no change or little change is needed for the flow execution unit 71 even if the components are different. Each of the component common I/Fs 79a includes the following I/Fs:
Generation
Execution of component (data)

The component group 79 illustrated in FIG. 7 includes a delivery component 75, a conversion component 76, and an external component collaboration component 77. These components are involved in actual processes included in a process flow.

The external component collaboration component 77 requests a component of the external component service 42, running on an external server, to perform a process.

The type conversion management unit 73 refers to a type conversion table (see Table 2) and manages a conversion process for converting data transmitted from the apparatus or data being processed in a process flow into a different data type that can be processed by a component.

The type conversion defining/processing unit 74 performs a conversion process for converting a given data type into a different data type. A type conversion common I/F 78 is an interface that can be used in common for any type conversion requested from the type conversion management unit 73. The type conversion common I/F 78 includes the following I/Fs:
Generation
Execution of type conversion process (data)

TABLE 1

| ID | NAME | DESCRIPTION | HOST |
|---|---|---|---|
| 0001 | CONVERSION | CONVERT | server1.com |
| 0002 | DELIVERY | DELIVER | server1.com |
| 0003 | CONVERSION 2 | CONVERT | server2.com |
| 0004 | DELIVERY 2 | DELIVER | server2.com |

Table 1 is an example of the determination table. By referring to the determination table, the program management unit 72 determines whether a component is located in an external server. The program management unit 72 can retain the determination table or can access the determination table in a storage. The determination table has items “name”, “description”, and “host” associated with identification information (ID) of each record. The “name” is the name of a process included in a process flow. The “description” is the description of the process. The “host” indicates a server where a component is located. If the “host” indicates “localhost”, the program management unit 72 determines that a component is located in the information processing system 50. If the “host” indicates any other location, the program management unit 72 determines that a component is located in an external server.

TABLE 2

| | DATA TYPE BEFORE | DATA TYPE AFTER |
|---|---|---|
| ID | CONVERSION | CONVERSION |
| 1 | InputStream | LocalFilePath |
| 2 | InputStream | File |
| 3 | File | LocaFilePath |
| 4 | . . . | . . . |

Table 2 indicates an example of the type conversion table managed by the type conversion management unit 73. A list of data conversion rules are registered in the type conversion table. Data types that can be handled by each component are predetermined. Thus, the type conversion defining/processing unit 74 converts a data type based on the type conversion table in response to a request from a component. In the type conversion table, an ID is associated with a data type before conversion and a data type after conversion. Accordingly, the developer can increase the number of components that can be connected to each other without modifying the components themselves.

### <External Component Service>

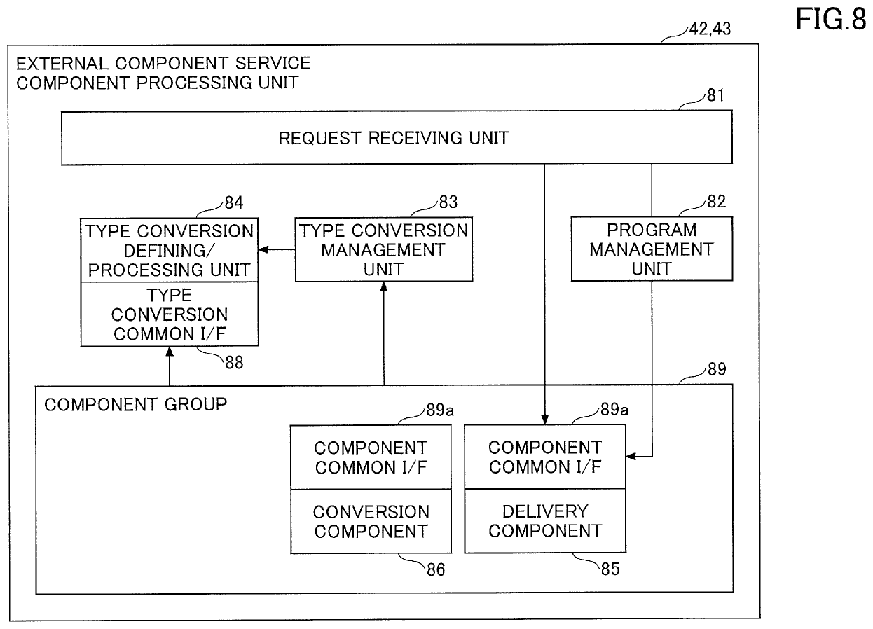

FIG. 8 is a functional block diagram illustrating functions of the component processing unit 43 of the external component service 42. The configuration of the component processing unit 43 is basically the same as the configuration of the I/O logic processing unit 59. However, because the external component service 42 is operated as a part of a process flow controlled by the I/O logic processing unit 59, the component processing unit 43 does not include a function to obtain details of the process flow from the application management unit 58. That is, the component processing unit 43 receives a request for a process, causes a component to perform the process, and returns the executed results to the I/O logic processing unit 59.

The structure of the components of the I/O logic processing unit 59 is the same as that of the components of the component processing unit 43. Therefore, the components can be successfully executed even if the components are placed in the I/O logic processing unit 59 or the component processing unit 43. Accordingly, after checking the quality of a component of the component processing unit 43, the service provider can transfer the component from the component processing unit 43 to the I/O logic processing unit 59 and execute the component in the I/O logic processing unit 59, or transfer the component from the I/O logic processing unit 59 to the external component service 42 and execute the component in the component processing unit 43, thereby enhancing the degree of freedom in placing components.

A request receiving unit 81 receives a request to execute a component from the I/O logic processing unit 59. The request receiving unit 81 executes the requested component. The request receiving unit 81 may receive a request to execute a plurality of components in a row.

A program management unit 82 retains the types of components. The program management unit 82 generates a component in response to a request from the request receiving unit 81.

A type conversion management unit 83, a type conversion defining/processing unit 84, a delivery component 85, and a conversion component 86 are involved in actual processes included in a process flow. A component common I/F 89a and a type conversion common I/F 88 are the same as those of the I/O logic processing unit 59.

### <<External Service Collaboration Unit>>

The external service collaboration unit 54 will be described in detail below. As described above, the external service collaboration unit 54 includes the file processing unit and the data processing unit. The file processing unit performs a process related to a file with respect to the external storage system 30 (such as transmitting/receiving a file to/from the external storage system 30). The data processing unit performs a process related to data that can be represented in text with respect to the external storage system 30 (such as obtaining a list of folders from the external storage system 30). Further, the file processing unit includes a common I/F 541 and a unique I/F 542, and the data processing unit includes a common I/F 543 and a unique I/F 544. Accordingly, for example, in order to deliver files to multiple external storage systems 30, the input/output service 55 can use common I/Fs of respective processing units such that the files can be delivered to the multiple external storage systems 30 through the same process. Further, the input/output service 55 can use unique I/Fs in order to utilize a wide range of functions of a given external storage system 30 or create an application specialized for a given external storage system 30.

A common I/F is an interface that can be used in common for a file-related service. The file processing unit 54a can transmit a file to a folder and obtain a file. The data processing unit 54b can receive a list of files and a list of folders.

A unique I/F is an interface that is used for a file-related service, but is not used in common. The file processing unit 54a can add a file to a document stored. The data processing unit 54b can obtain a list of customers, a list of image files, and the like.

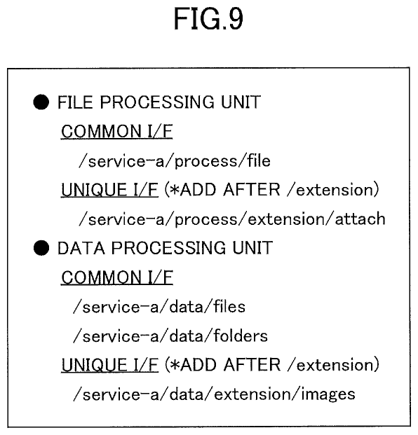

FIG. 9 is a diagram illustrating examples of common I/Fs and unique I/Fs. For the common I/Fs, slashes “/” are used to specify folders and files. For the unique I/Fs, “/extension” is included in each of the unique I/Fs.

### <Process Flow>

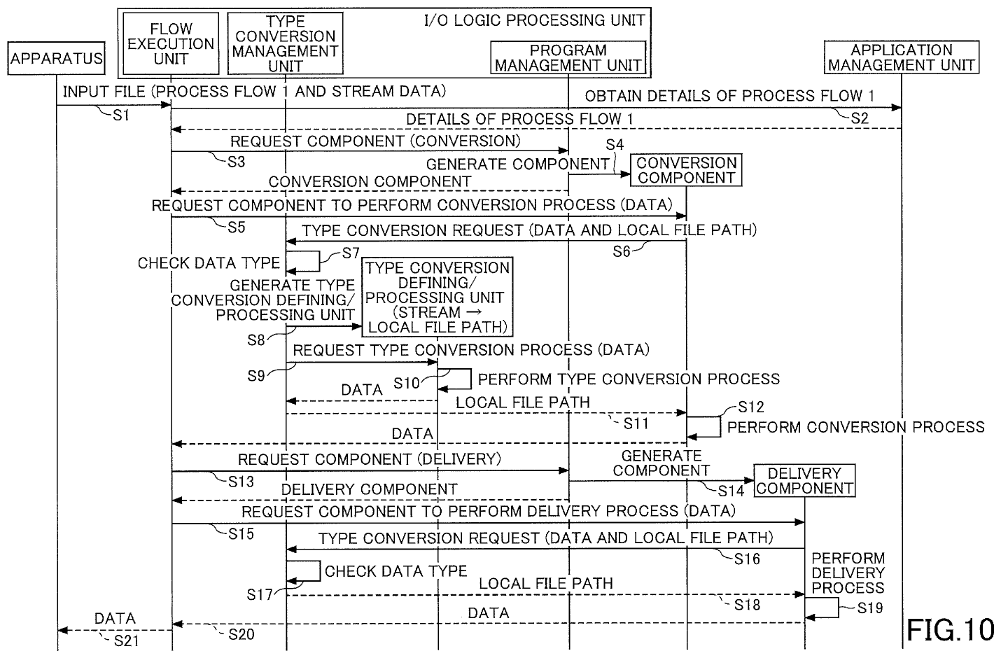

Next, a process flow as controlled by the I/O logic processing unit 59 will be described with reference to FIG. 10. FIG. 10 is a sequence diagram illustrating an example of a process flow performed by the information processing system 50. In FIG. 10, an example in which the I/O logic processing unit 59 executes a component located in the information processing system 50 will be described.

In S1, the user inputs an operation for performing a process flow into the apparatus 20. The operation receiving unit 23 of the apparatus 20 receives the operation. As a result, a file (a process flow 1 and stream data) is generated. The stream data is data to be processed in the process flow. As data types, there are “stream” and “file”. As used herein, the term “stream data” is a flow of data that is sent continuously from the apparatus 20. The communication unit 21 transmits the file to the information processing system 50.

In S2, the communication unit 61 of the information processing system 50 receives the file. The flow execution unit 71 obtains details of the process flow 1 from the application management unit 58. The process flow 1 includes a “conversion” process and a “delivery” process. The “conversion” process and the “delivery” process are performed by components included in the information processing system 50.

In S3, the flow execution unit 71 sends a request for a conversion component 76 to the program management unit 72 in order to perform the first “conversion” process.

In S4, the program management unit 72 generates a conversion component 76, and sends the conversion component 76 to the flow execution unit 71.

In S5, the flow execution unit 71 requests the conversion component 76 to perform the “conversion” process. At this time, the flow execution unit 71 passes “data” to the conversion component 76. The “data” is actually the stream data input into the apparatus 20.

In S6, upon receiving the request, the conversion component 76 sends a type conversion request to the type conversion management unit 73. The type conversion request includes the “data” received from the flow execution unit 71, and a data type that can be handled by the conversion component 76. In this example, it is assumed that a local file path (a file path in which the data after type conversion is to be stored) is requested.

The conversion component 76 requests data type conversion without being conscious of the actual type of the received data. In this example, the stream data is actually received as the “data”, but the conversion component 76 simply receives the “data” as a common concept regardless of the type of the data, and requests a reusable file path in which the data is stored. Accordingly, it becomes possible for components to have common I/Fs, and not to be conscious of data types other than data types than can be handled by each of the components.

In S7, the type conversion management unit 73 checks the type of the received “data” by referring to the type conversion table of Table 2. In this example, the “data” is the stream data. Therefore, the type conversion management unit 73 determines to convert the data into a data type that can be handled by the conversion component 76.

In S8, the type conversion management unit 73 generates a type conversion defining/processing unit 74 that converts the data into a data type requested by the conversion component 76. Note that the user can increase process flow patterns by increasing type conversion process patterns.

In S9, the type conversion management unit 73 requests the generated type conversion defining/processing unit 74 to perform a type conversion process.

In S10, the type conversion defining/processing unit 74 performs the type conversion process, and sends the obtained results (that is, the data after type conversion) to the type conversion management unit 73.

In S11, the type conversion management unit 73 stores the data after type conversion in a local file path, and sends the local file path to the conversion component 76.

In S12, the conversion component 76 performs the “conversion” process on the data stored in the local file path. The conversion process performed by the conversion component 76 may be OCR, translation, or any other data process. The conversion component 76 sends the converted “data” to the flow execution unit 71. The type of the “data” converted by the conversion component 76 may be any type because the next component requests data conversion in the same manner. The conversion component 76 sends the “data” of any type. In this example, it is assumed that the type of the “data” is a “local file path”.

In S13, the next “delivery” process is performed in a similar manner. The flow of the “delivery” process is basically the same as that of the “conversion” process. The flow execution unit 71 sends a request for a delivery component 75 to the program management unit 72 in order to perform the next “delivery” process.

In S14, the program management unit 72 generates a delivery component 75, and sends the delivery component 75 to the flow execution unit 71.

In S15, the flow execution unit 71 requests the delivery component 75 to perform the “delivery” process. At this time, the flow execution unit 71 passes “data” to the delivery component 75. The “data” is actually the local file path.

In S16, upon receiving the request, the delivery component 75 sends a type conversion request to the type conversion management unit 73. The type conversion request includes the “data” received from the flow execution unit 71, and a data type that can be handled by the delivery component 75. In this example, it is assumed that a local file path (a file path in which the data is to be stored) is requested. In the conversion process, because the “local file path” is passed to the delivery component 75 as the “data”, the “data” is the “local file path”. Therefore, data type conversion is actually unnecessary.

In S17, the type conversion management unit 73 checks the type of the “data” by referring to the type conversion table of Table 2. Because the “data” is the “local file path”, data type conversion is not performed.

In S18, the type conversion management unit 73 sends the local file path (data) to the delivery component 75.

In S19, the delivery component 75 performs the “delivery” process on the data stored in the local file path. Namely, the delivery component 75 delivers the data. In other words, the delivery component 75 transmits the data to the external storage system 30.

In S20, the delivery component 75 transmits data obtained as a result of the process, to the flow execution unit 71. Such data obtained as a result of a process varies depending on the component. For example, in the case of delivery, the data obtained as a result of the delivery may be a file name and a date and time. In the case of translation, data obtained as a result of the translation may be translated data.

In S21, the flow execution unit 71 transmits the data (executed results) to the apparatus 20 via the communication unit 61. The apparatus 20 receives the data via the communication unit 61.

In this manner, the information processing system 50 executes the components included in the process flow in order.

### <Process Flow Performed by Component Processing Unit>

Next, a process flow performed by the component processing unit 43 of the external server will be described for comparison.

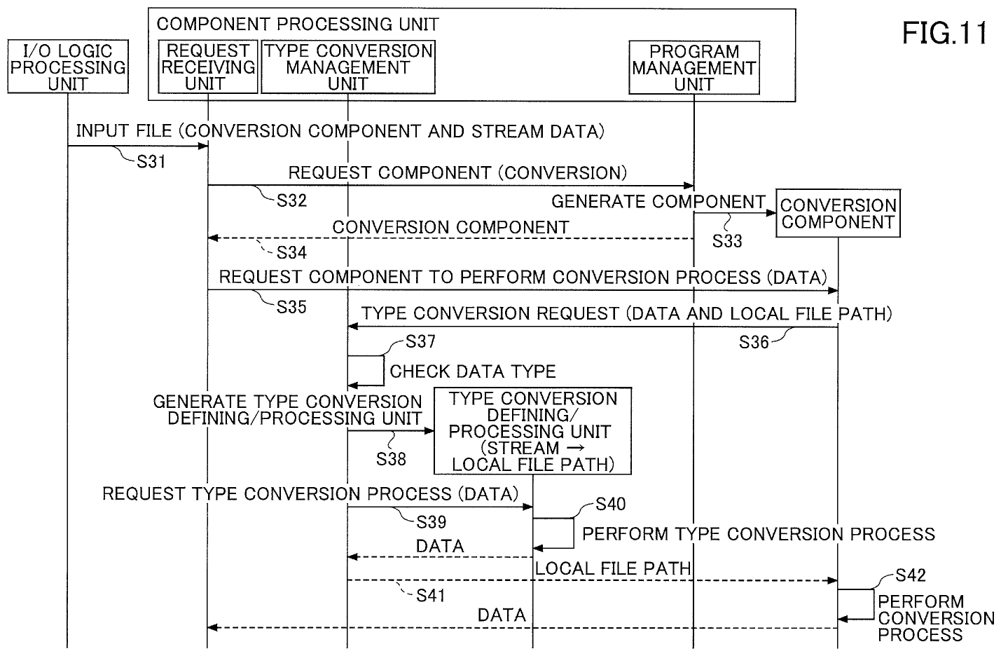

FIG. 11 is a sequence diagram illustrating an example of a process flow executed by the component processing unit 43 according to the present embodiment. In FIG. 11, differences from the process flow illustrated in FIG. 10 will be described.

The external component service 42 is operated as a part of a process flow controlled by the I/O logic processing unit 59. Therefore, the external component service 42 does not obtain details of a process flow from the application management unit 58. Steps S31 through S42 are similar to steps S1 and S3 through S12 of FIG. 10. Note that the description of the delivery process is not provided in FIG. 11.

<Process Flow including Components Located in External Component Service and Performed by I/O Logic Processing Unit>

Next, a process flow that includes components located in the external component service 42 and components located in the processing system 50 will be described.

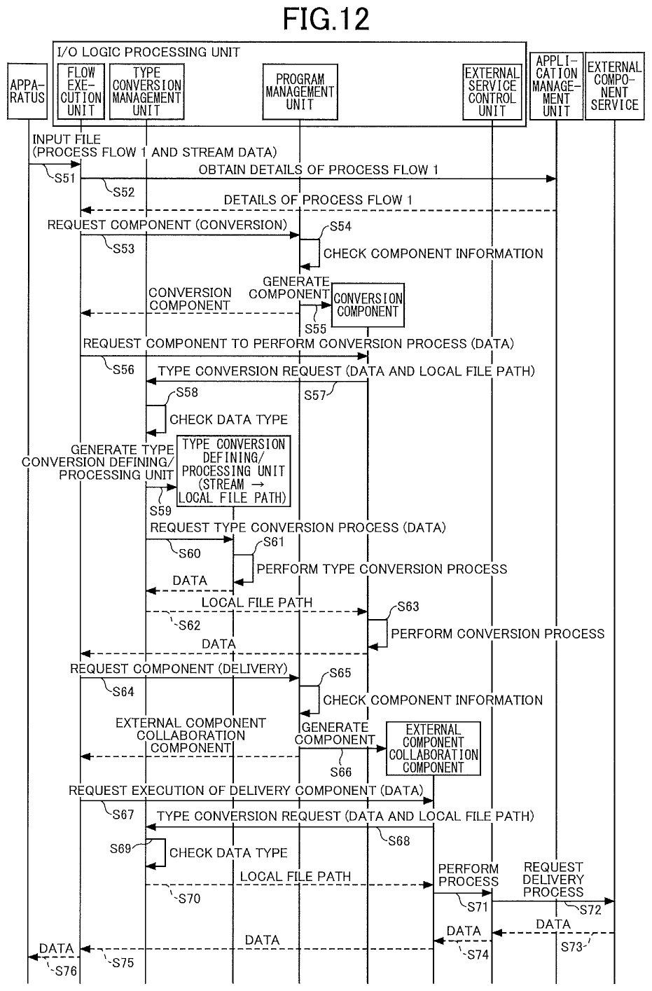

FIG. 12 is a sequence diagram in which the I/O logic processing unit 59 performs a process flow that includes components located in the external component service 42 and components located in the processing system 50. Note that a process flow 1 of FIG. 12 includes a “conversion” process and a “delivery” process. In FIG. 12, differences from the process flow illustrated in FIG. 10 will be mainly described.

Steps S51 and S52 of FIG. 12 may be the same as steps S1 and S2 of FIG. 10. Next, the flow execution unit 71 sends a request for a conversion component to the program management unit 72 (S53).

In response to the request, the program management unit 72 determines whether the conversion component is located in the information processing system 50 or located in an external server by referring to the determination table of Table 1 (S54). In this example, it is determined that the conversion component is located in the information processing system 50.

Steps S55 through S63 may be the same as steps S4 through S12 of FIG. 10.

Next, in S64, the flow execution unit 71 sends a request for a “delivery” component to the program management unit 72.

In S65, the program management unit 72 determines whether the requested delivery component is located in an external server by referring to the determination table of Table 1. In this example, it is determined that the delivery component is located in an external server.

In S66, the program management unit 72 generates an external component collaboration component 77, and sends the external component collaboration component 77 to the flow execution unit 71. At this time, the program management unit 72 passes “data” to the flow execution unit 71. The “data” is actually a local file path.

In S67, the flow execution unit 71 requests the component collaboration component 77 to execute the “delivery” component by specifying the data (local file path).

In S68, upon receiving the request, the external component collaboration component 77 sends a type conversion request to the type conversion management unit 73. The type conversion request includes the “data” received from the flow execution unit 71, and a data type that can be handled by the external component collaboration component 77. In this example, the conversion component 76 specifies a local file path. In the conversion process, because the “local file path” is passed as the “data”, the “data” is the “local file path”. Therefore, data type conversion is actually unnecessary.

In S69, the type conversion management unit 73 checks the type of the “data”. Because the “data” is the “local file path”, data type conversion is not performed.

In S70, the type conversion management unit 73 sends the local file path to the external component collaboration component 77.

In S71, the external component collaboration component 77 performs a process on the data stored in the local file path. Specifically, because the external component collaboration component 77 is a component for working with the external server system 40, the external component collaboration component 77 requests the external service control unit 57 to perform the “delivery” process.

In S72, the external service control unit 57 requests the external component service 42 to perform the “delivery” process. Accordingly, a process flow as illustrated in FIG. 11 is performed by the component processing unit 43 of the external component service 42.

In S73 through S76, data (executed results) is transmitted to the apparatus 20 as in the case of FIG. 10.

### <Controlling Operational State of External Server>

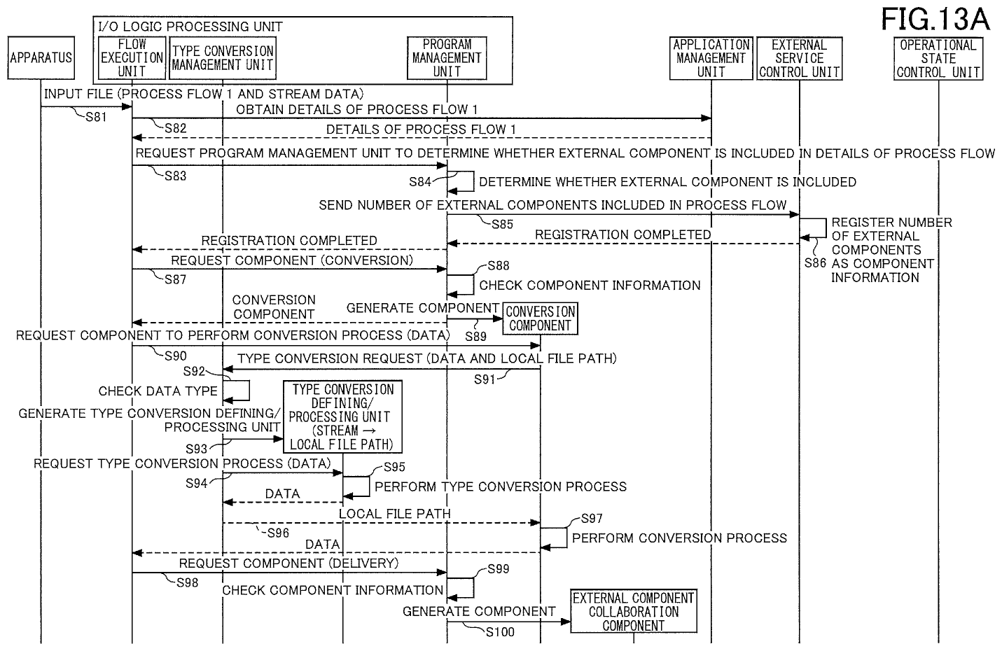

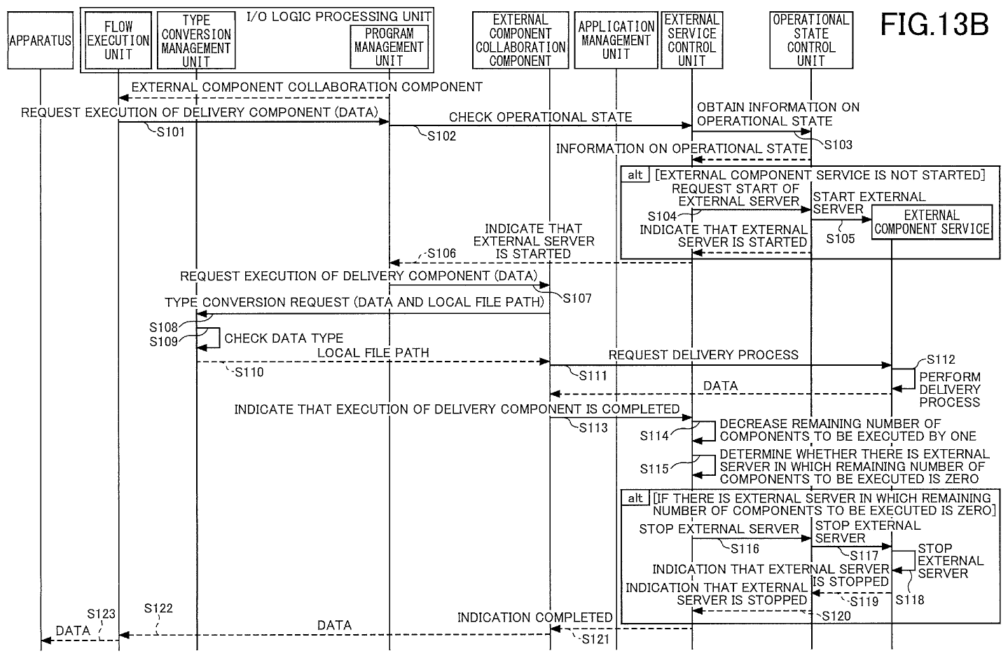

In the process flow illustrated in FIG. 12, the external server is in operation at all times. Therefore, unnecessary costs are required. Referring now to FIG. 13A and FIG. 13B, a process for controlling the operational state of an external server by the information processing system 50 will be described. FIG. 13A and FIG. 13B are sequence diagrams illustrating an example in which the information processing system 50 performs a process flow and controls the operational state of an external server.

The process flow illustrated in FIG. 13A and FIG. 13B is the same as that of FIG. 12, except that a process for controlling the operational state of an external server is combined with the process flow.

In S81, the user inputs an operation for performing a process flow into the apparatus 20. The operation receiving unit 23 of the apparatus 20 receives the operation. As a result, a file (a process flow 1 and stream data) is generated. The stream data is data to be processed in the process flow. The communication unit 21 transmits the file to the information processing system 50.

In S82, the communication unit 61 of the information processing system 50 receives the file. The flow execution unit 71 obtains details of the process flow 1 from the application management unit 58. The process flow 1 includes a “conversion” process and a “delivery” process. In this example, it is assumed that the “delivery” process is performed by a component of an external server. The application management unit 58 sends the details of the process flow 1 to the flow execution unit 71.

In S83, the details of the process flow 1 include information on components that perform processes. The flow execution unit 71 passes the details of the process flow 1 to the program management unit 72, and requests the program management unit 72 to determine whether any of the components included in the details of the process flow 1 is located in an external server.

In S84, the program management unit 72 determines whether the components, included in the details of the process flow 1 (and to be executed by the information processing system 50), are located in the information processing system 50 or in an external server by referring to details of the process flow and the determination table of Table 1.

In S85, the program management unit 72 counts the number of external components included in the process flow 1, and sends the number of external components to the external service control unit 57.

In S86, the external service control unit 57 registers the number of external components included in the process flow 1. The number of external components is registered as component information 52 as illustrated in FIG. 5. The component information 52 includes external server information (a host name) representing an external server, and the remaining number of components to be executed in the external server. In this manner, before a first process included in a series of processes is performed, the number of external components to be executed in the external server is stored. Note that external components, included in process flows that are performed in parallel, are summed. For example, if process flows are performed in parallel by two users and each of the process flows includes an external component located in an external server, the number of components to be executed in the external server is “2”.

In S87 through S97, after the registration is completed, the flow execution unit 71 requests the generation of a component and request the component to perform the “conversion” process, in accordance with the details of the process flow 1. Steps S87 through S97 may be the same as steps S53 through S63 of FIG. 12.

In S98, upon the completion of the first “conversion” process, the flow execution unit 71 sends a request for a “delivery” component to the program management unit 72.

In S99, the program management unit 72 determines whether the requested delivery component is located in the information processing system 50 or in an external server by referring to the determination table of Table 1.

In S100, if the delivery component is located in an external server, the program management unit 72 generates an external component collaboration component 77.

In S101, the flow execution unit 71 requests the program management unit 72 to execute the delivery component.

In S102, the program management unit 72 requests the external service control unit 57 to check the operational state of the external server in which the requested delivery component is located.

In S103, the external service control unit 57 obtains information on the operational state of the external server from the operational state control unit 41. Accordingly, the operational state of the external server is obtained at a timing when the program (delivery component, in this example) that performs the process (delivery process, in this example) included in the series of processes is executed.

If the external server in which the delivery component is located is not started (the operational state indicates that the external server is not started), steps S104 and S105 are performed.

In S104, if the external server is not started, the external service control unit 57 requests the operational state control unit 41 to start the external server.

In S105, the operational state control unit 41 starts the external server in which the requested delivery component is located. In addition, upon the start of the external server, the external component service 42 is automatically started. In response to an explicit request from the operational state control unit 41, the external component service 42 may be started.

In S106, upon the start of the external server, the external service control unit 57 indicates that the external server is started to the program management unit 72.

In S107 through S112, upon receiving the indication that the external server is started from the external service control unit 57, the program management unit 72 requests the external component collaboration component 77 to execute the delivery component. The delivery component performs the delivery process in the external component service 42. Steps S107 through S112 may be similar to steps S67 through S72 of FIG. 12.

In S113, after the completion of the delivery process, the external component collaboration component 77 indicates that the execution of the delivery component is completed to the external service control unit 57.

In S114, the external service control unit 57 decreases the remaining number of components to be executed in the external server by one.

In S115, the external service control unit 57 determines whether there is an external server (host) in which the remaining number of components to be executed is zero (“0”).

In S116, if there is an external server in which the remaining number of components to be executed is zero, the external service control unit 57 requests the operational state control unit 41 to stop the external server. In this manner, the external server is stopped when the remaining number of components to be executed is zero.

In the example of FIG. 13B, the external service control unit 57 determines whether the remaining number of components to be executed is zero. However, upon the completion of the process included in the series of processes, the external service control unit 57 may obtain the operational state of the external server. In this case, if the external server is in operation (the operational state indicates that the external server is in operation), the external service control unit 57 may request the operational state control unit 41 to stop the external server.

In S117, the operational state control unit 41 requests the external component service 42 to stop (end) the external server.

In S118, the external component service 42 stops the external server in accordance with the specifications of the external server. That is, a resource secured for the external component service 42 of the cloud service is released. In other words, the user is no longer charged for the resource. Note that the resource is not necessarily released as long as the user is not charged.

In S119 and S120, the stop of the external server is indicated to the external service control unit 57.

In S121, the external service control unit 57 indicates the indication is completed to the external component collaboration component 77.

In S122 and S123, data (executed results) is transmitted to the apparatus 20.

Accordingly, the information processing system 50 according to the present embodiment allows an external server to be in operation while the external server needs to be operated. Therefore, unnecessary costs related to management and storage of components by the external server can be reduced.

### <When Plurality of External Components are Included in Process Flow>

In the example illustrated in FIGS. 13A and 13B, the one external component is included in the details of the process flow. In the following, an example in which a single process flow includes a plurality of components to be executed in an external server will be described.

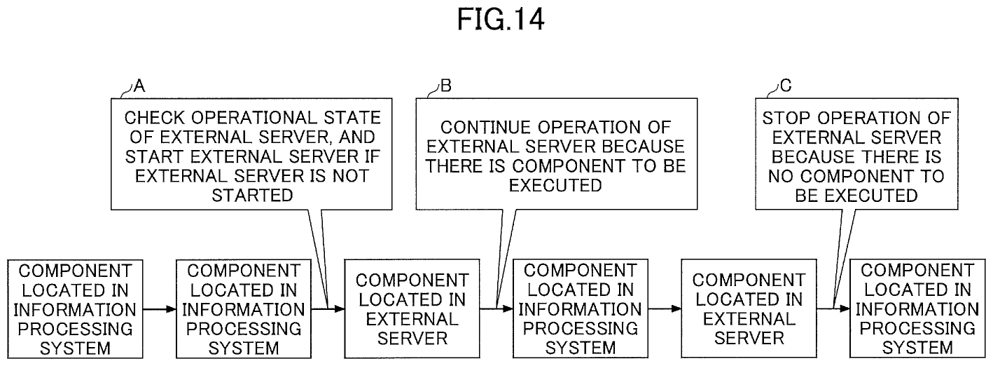

FIG. 14 is a diagram illustrating an example of a process flow that includes a plurality of components to be executed in an external server.

A. If the I/O logic processing unit 59 performs a process flow as illustrated in FIGS. 13A and 13B, the program management unit 72 checks the operational state of an external server in which components to be executed are located. If the external server is not started, the program management unit 72 starts the external server (as in step S105 of FIG. 13B).

B. Upon the execution of a first component located in the external server, the program management unit 72 determines whether there is any other component to be executed in the external server. In this example, because there is a second component to be executed, the program management unit 72 continues the operation of the external server (in the example of FIG. 13B, it is determined that the remaining number of components to be executed is not zero in step S115).

C. Upon the execution of the second component in the external server, the program management unit 72 checks whether there is any other component to be executed in the external server. In this example, because there is no other component to be executed, the program management unit 72 stops the operation of the external server (as in step S118 of FIG. 13B).

The example described above applies not only when a single process flow includes a plurality of components, but also when a plurality of process flows include a single component.

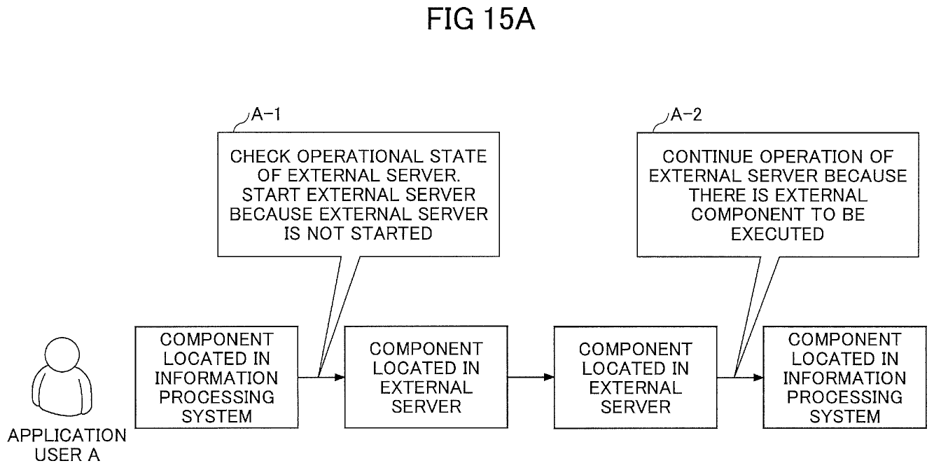

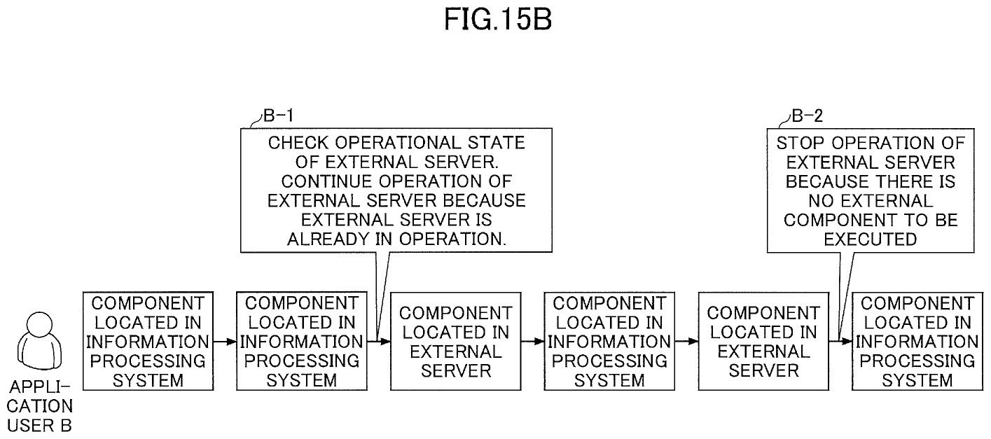

FIG. 15A and FIG. 15B are diagrams illustrating an example in which process flows, including a plurality of components to be executed in an external server, are performed in parallel by a plurality of users. FIG. 15A depicts a process flow performed by a user A, and FIG. 15B depicts a process flow performed by a user B. The external server includes the plurality of components. When the plurality of components are executed in the same external server by performing the process flows in parallel, the external server is stopped upon the completion of the execution of all the components.

A-1. The program management unit 72 checks the operational state of the external server. In this case, the program management unit 72 starts the external server because the external server is not started.

B-1. The program management unit 72 checks the operational state of the external server. In this case, the program management unit 72 continues the operation of the external server because the external server is already in operation.

A-2. In the process flow performed by the user A, the execution of components located in the external server is completed. However, in the process flow performed by the user B, there is a component that is yet to be executed (the remaining number of components to be executed in the external server is not zero). Therefore, the program management unit 72 continues the operation of the external server.

B-2. In the process flow performed by the user B, there is no other component to be executed in the external server (the remaining number of components to be executed in the external server is zero). Therefore, the program management unit 72 stops the operation of the external server.

As described above, components included in a plurality of process flows performed in parallel by a plurality of users are summed. Therefore, even if the users perform the process flows in parallel, the information processing system 50 can control the operational state of an external server in accordance with whether there is any component to be executed in the external server.

### <Redundant Configuration of Information Processing System>

In order to enhance the availability of the information processing system 50, some functions of the information processing system 50 may have redundancy.

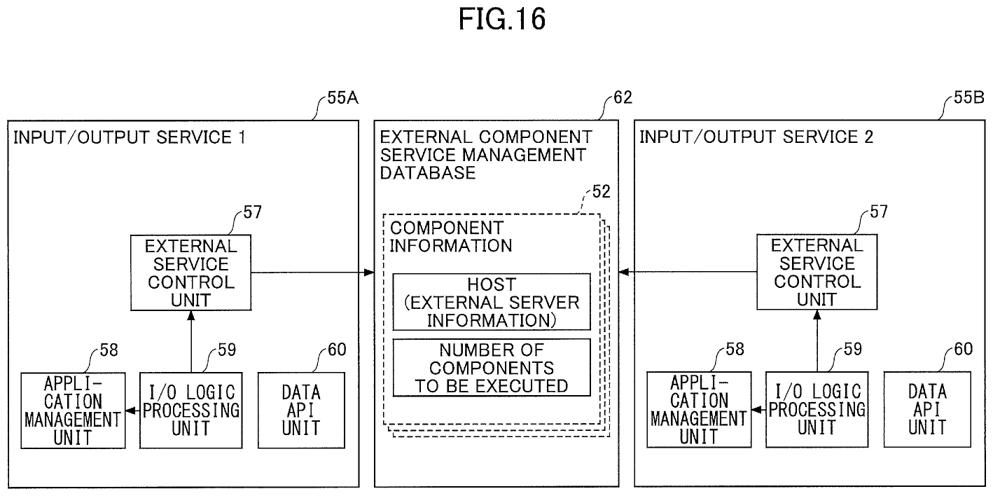

FIG. 16 is a diagram illustrating an external component service management database 62, which is included in the information processing system 50 if the information processing system 50 has a redundant configuration. In the redundant configuration illustrated in FIG. 16, the information processing system 50 includes input/output services 55A and 55B. Each of the input/output services 55A and 55B may have the same functions as those of the input/output service illustrated in FIG. 4.

The external component service management database 62 is a database that manages component information 52. The component information 52 includes the remaining number of components to be executed, among components included in details of a process flow obtained by the flow execution unit 71. In the component information 52, the remaining number of components to be executed is associated with a corresponding host.

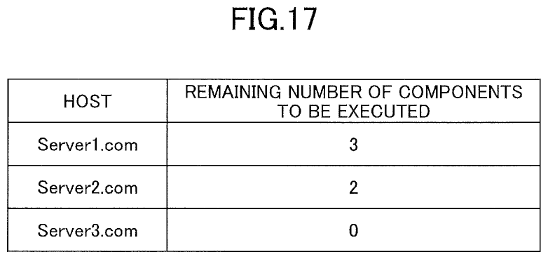

If the information processing system 50 has a redundant configuration, information on each external component service 42 needs to be shared among a plurality of modules. If such information is stored in a database as illustrated in FIG. 17, instead of being retained by the external service control unit 57 as illustrated in FIG. 4, the information can be shared among the plurality of modules.

FIG. 17 is a diagram illustrating the structure of the external component service management database 62. The external component service management database 62 indicates the use state of each external component service 42. In the external component service management database 62, the remaining number of external components is associated with a corresponding host. The “host” indicates an external server (such as a domain name). The “remaining number of external components” indicates the number of components that are yet to be executed (in the external server) among components included in details of a process flow.

### <Process Flow Performed by Information Processing System Having Redundant Configuration>

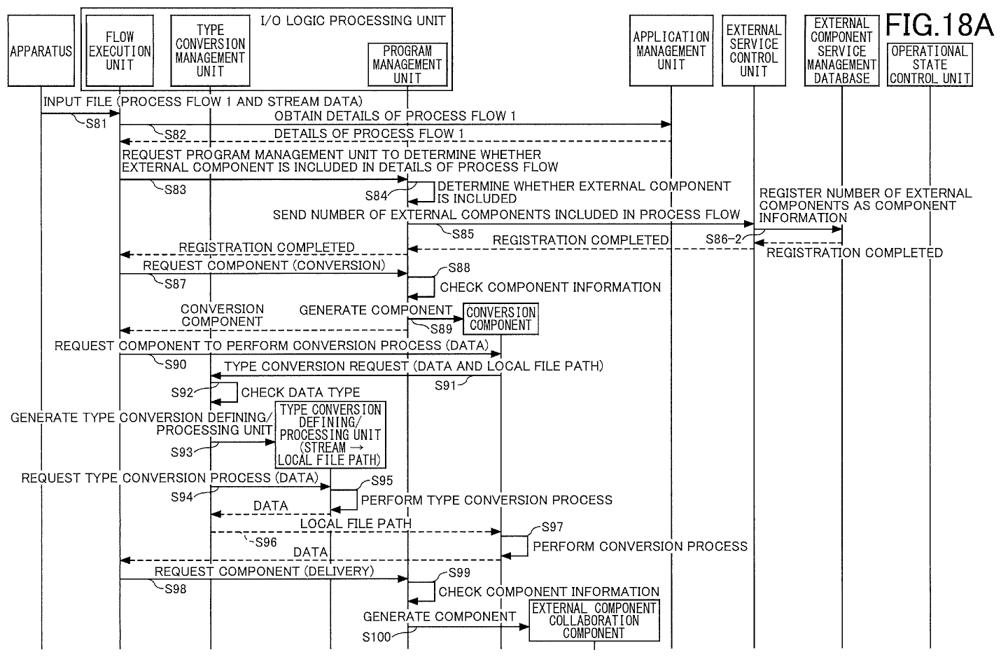

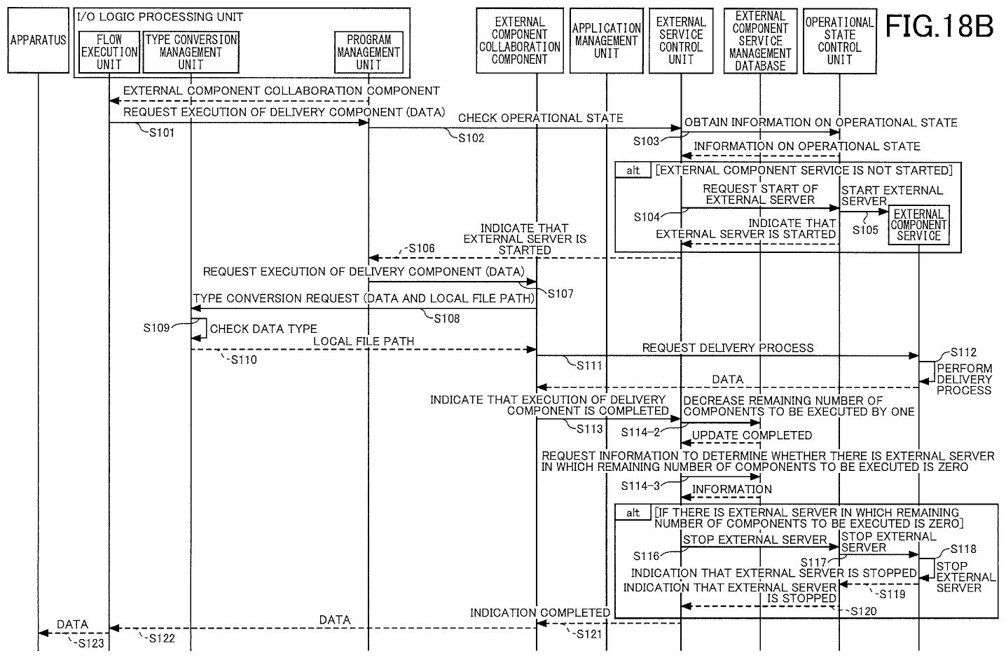

FIG. 18A and FIG. 18B are sequence diagrams illustrating an example of a process flow performed by the information processing system 50 having a redundant configuration. In the example illustrated in FIG. 18A and FIG. 18B, information on the remaining number of components to be executed is registered in the external component service management database 62, instead of being retained by the external service control unit 57. Therefore, in FIG. 18A and FIG. 18B, a part of the process flow in which information is registered and updated differs from that of FIGS. 13A and 13B, and other parts of the process flow are the same as those of FIGS. 13A and 13B. In the example of FIG. 18A and FIG. 18B, differences from FIG. 13A and FIG. 13B will be mainly described.

In S86-2, the external service control unit 57 registers the number of external components included in the process flow in the external component service management database 62. Specifically, external components are summed on a per-host basis.

In S114-2, the external service control unit 57 requests the external component service management database 62 to decrease the remaining number of external components to be executed by one.

In S114-3, the external service control unit 57 requests information on the remaining number of components to be executed to determine whether there is an external server (host) in which the remaining number of components to be executed is zero.

In this manner, information on each external component service 42 is shared among a plurality of modules. Accordingly, even if the input/output service 55 has a redundant configuration, the external service control unit 57 can refer to and update the remaining number of external components to be executed.

### <Main Effects>

As described above, the information processing system 50 determines whether to continue the operation of an external server for each component located in the external server. If the information processing system 50 determines that the operation of the external server is not required, the information processing system 50 stops the operation of the external server. Accordingly, unnecessary costs related to management and storage of components in the external server can be reduced.

### <Supplementary Information>

Although the embodiments have been specifically described above, the present invention is not limited to the specific embodiments and various modifications and variations may be made without departing from the scope of the present invention.

For example, at least a part of functional components of the information processing system 50 may be included in an apparatus such as an image forming apparatus. For example, the information processing system 50 may cause the image forming apparatus to execute at least a part (for example, a printing process, a scanning process, a facsimile transmission process, or the like) of a plurality of processes defined in a process flow.

Each of the functional components of the above-described embodiments may be implemented by one or more processing circuits. As used herein, the “processing circuit” may include a processor programmed to perform each function by software, such as a processor implemented in electronic circuits, an application specific integrated circuit (ASIC) designed to perform each function as described above, a digital signal processor (DSP), a field programmable gate array (FPGA), or a conventional circuit module.

Further, the apparatuses described above merely indicate one of a plurality of computing environments for implementing the embodiments described in the present application.

In one embodiment, the information processing system 50 may include a plurality of computing devices such as server clusters. The plurality of computing devices may be configured to communicate with each other via a communication link such as a network or a shared memory, and perform processes described in the present application. Similarly, the apparatus 102 may include a plurality of computing devices configured to communicate with each other.

Further, the elements of the information processing system 50 may be integrated into one server apparatus or may be separated into a plurality of apparatuses.

According to an embodiment of the present invention, an information processing system that can control the operational state of an external server in accordance with a program included in a process flow can be provided.

What is claimed is:

1. An information processing system configured to communicate with an apparatus and an external server and to perform a series of processes, the series of processes being specified by the apparatus,
the information processing system comprising:
a memory; and
a processor coupled to the memory and configured to
identify a program that is executed in the external server based on the series of processes specified by the apparatus, and
control an operational state of the external server in which the identified program is executed.

2. The information processing system according to claim 1, wherein the processor obtains the operational state of the external server at a timing when the identified program, that performs a process included in the series of processes, is executed, and
the processor causes the external server to start in a case where the obtained operational state indicates that the external server is not started.

3. The information processing system according to claim 2, wherein the processor obtains the operational state of the external server at a timing when the process included in the series of processes is completed, and
the processor causes the external server to stop in a case where the obtained operational state indicates that the external server is in operation.

4. The information processing system according to claim 1, wherein, from among programs that perform the series of processes, the processor retains a number of programs to be executed in the external server before a first process included in the series of processes is performed, and
the processor decreases the number of programs by one in response to completion of execution of a given program included in the programs to be executed in the external server.

5. The information processing system according to claim 4, wherein the processor causes the external server to stop at a timing when the number of programs to be executed in the external server becomes zero.

6. The information processing system according to claim 4, wherein in a case where a plurality of series of processes are specified by respective apparatuses and performed in parallel, the processor sums and retains a number of programs to be executed in the external server from among programs that perform the plurality of series of processes.

7. The information processing system according to claim 4, further including
a plurality of processors configured to operate in a redundant configuration, and
a database configured to retain the number of programs to be executed in the external server from among the programs that perform the series of processes,
wherein the plurality of processors refer to the database.

8. The information processing system according to claim 1, wherein a charge is issued based on a period of time during which the external server is in operation, and the processor controls the operational state of the external server such that the charge is issued or is not issued.

9. A process executing system comprising:
an apparatus; and
an information processing system configured to communicate with the apparatus and an external server and to perform a series of processes,
wherein the apparatus includes a first memory and a first processor coupled to the first memory and configured to
receive selection of the series of processes, and
request the information processing system to perform the series of processes, and
wherein the information processing system includes a second memory and a second processor coupled to the second memory and configured to
identify a program that is executed in the external server based on the series of processes requested by the apparatus, and
control an operational state of the external server in which the identified program is executed.

10. A process executing method performed by an information processing system configured to communicate with an apparatus and an external server and to perform a series of processes, the series of processes being specified by the apparatus, the method comprising:
identifying a program that is executed in the external server based on the series of processes specified by the apparatus, and
controlling an operational state of the external server in which the identified program is executed.

11. A non-transitory recording medium storing a program for causing an information processing system to execute a process, the information processing system being configured to communicate with an apparatus and an external server and configured to perform a series of processes, the series of processes being specified by the apparatus, the process comprising:
identifying a program that is executed in the external server based on the series of processes specified by the apparatus, and
controlling an operational state of the external server in which the identified program is executed.
